(19) United States
(12) Patent Application Publication
(10) Pub. No.: US 2026/0212815 A1
(43) Pub. Date: Jul. 23, 2026

(54) PIXEL AND DISPLAY DEVICE INCLUDING THE SAME

(71) Applicant: Samsung Display Co., Ltd., Yongin-si (KR)

(72) Inventors: JUNKI JEONG, Yongin-si (KR); Jongyeop An, Yongin-si (KR); JUNGHWAN HWANG, Yongin-si (KR)

(21) Appl. No.: 19/359,314

(22) Filed: Oct. 15, 2025

(30) Foreign Application Priority Data
Jan. 23, 2025 (KR) 10-2025-0009999

(51) Int. Cl. G09G 3/3233

(52) U.S. Cl. CPC G09G 3/3233; G09G 2300/0804; G09G 2300/0819; G09G 2300/0852; G09G 2300/0861; G09G 2310/08; G09G 2320/0666

(57) ABSTRACT

A pixel includes: a first color light-emitting element to display a first color; a second color light-emitting element to display a second color; a third color light-emitting element to display a third color; and a pixel circuit connected to the first, second, and third color light-emitting elements and provides a driving current to the first color light-emitting element, the second color light-emitting element, or the third color light-emitting element, wherein the pixel circuit includes: a first transistor including a gate electrode connected to a first node, a first electrode connected to a second node, and a second electrode connected to a third node; a second transistor configured to connect a data line and the first node; a third transistor configured to provide a compensation voltage to the second node; and a fourth transistor configured to provide a low power supply voltage to the third node.

### CROSS-REFERENCE TO RELATED APPLICATION

The present application claims priority to and the benefit of Korean Patent Application No. 10-2025-0009999, filed on Jan. 23, 2025, in the Korean Intellectual Property Office, the entire disclosure of which is incorporated by reference herein.

### BACKGROUND

### 1. Field

The present disclosure relates to a pixel and a display device including the same.

### 2. Description of the Related Art

In general, a display device includes a display panel and a display panel driver. The display panel includes gate lines, data lines, emission lines, and pixels. The display panel driver includes a gate driver for providing a gate signal to the gate lines, a data driver for providing a data voltage to the data lines, an emission driver for providing an emission signal to the emission lines, and a driving controller for controlling the gate driver, the data driver, and the emission driver.

Recently, display devices that provide virtual reality (VR) or augmented reality (AR) are highlighted. For this purpose, the display devices are required to have a small area and high PPI (Pixels Per Inch). In this case, because a pitch occupied by a pixel is narrow, there may be restrictions on a number of transistors that constitute the pixel and the a signal applied to the pixel.

### SUMMARY

Embodiments of the present disclosure provide a pixel for a low area and a high pixels per inch (PPI).

Embodiments of the present disclosure provide a display device including the pixel.

In one or more embodiments of the present disclosure a pixel includes: a first color light-emitting element configured to display a first color; a second color light-emitting element configured to display a second color; a third color light-emitting element configured to display a third color; and a pixel circuit connected to the first color light-emitting element, the second color light-emitting element, and the third color light-emitting element and configured to provide a driving current to the first color light-emitting element, the second color light-emitting element, or the third color light-emitting element, wherein the pixel circuit includes: a first transistor including a gate electrode connected to a first node, a first electrode connected to a second node, and a second electrode connected to a third node; a second transistor configured to connect a data line and the first node in response to a data write gate signal; a third transistor configured to provide a compensation voltage to the second node in response to a compensation gate signal; and a fourth transistor configured to provide a low power supply voltage to the third node in response to an emission signal.

In one or more embodiments, the first to fourth transistors are N-type transistors.

In one or more embodiments, the first color light-emitting element includes an anode electrode configured to receive a first color high power supply voltage and a cathode electrode connected to the second node, wherein the second color light-emitting element includes an anode electrode configured to receive a second color high power supply voltage and a cathode electrode connected to the second node, and wherein the third color light-emitting element includes an anode electrode configured to receive a third color high power supply voltage and a cathode electrode connected to the second node.

In one or more embodiments, the second transistor includes a gate electrode configured to receive the data write gate signal, a first electrode connected to the data line, and a second electrode connected to the first node.

In one or more embodiments, the third transistor includes a gate electrode configured to receive the compensation gate signal, a first electrode configured to receive the compensation voltage, and a second electrode connected to the second node.

In one or more embodiments, the fourth transistor includes a gate electrode configured to receive the emission signal, a first electrode configured to receive the low power supply voltage, and a second electrode connected to the third node.

In one or more embodiments, the pixel circuit further includes a first capacitor including a first electrode connected to the first node and a second electrode connected to the third node.

In one or more embodiments, the pixel circuit further includes a second capacitor including a first electrode connected to the third node and a second electrode configured to receive the low power supply voltage.

In one or more embodiments, a frame period for the pixel includes a first sub-frame period for driving the first color light-emitting element, a second sub-frame period continuous to the first sub-frame period for driving the second color light-emitting element, and a third sub-frame period continuous to the second sub-frame period for driving the third color light-emitting element.

In one or more embodiments, each of the first to third sub-frame periods includes a first period, a second period, a third period, and a fourth period, wherein in the first period, the data write gate signal has a high level, the compensation gate signal has a low level, the emission signal has the high level, and the data line is configured to transmit a reference voltage, wherein in the second period, the data write gate signal has the high level, the compensation gate signal has the high level, the emission signal has the low level, and the data line is configured to transmit the reference voltage, wherein in the third period, the data write gate signal has the high level, the compensation gate signal has the low level, the emission signal has the low level, and the data line is configured to transmit a data voltage, and wherein in the fourth period, the data write gate signal has the low level, the compensation gate signal has the low level, the emission signal has the high level, and the data line is configured to transmit the reference voltage.

In one or more embodiments, in the first sub-frame period, a second color high power supply voltage and a third color high power supply voltage have the low level, a first color high power supply voltage has the low level in the first to third periods, and the high level in the fourth period, wherein in the second sub-frame period, the third color high power supply voltage and the first color high power supply voltage have the low level, the second color high power supply voltage has the low level in the first to third periods, and the high level in the fourth period, and wherein in the third sub-frame period, the first color high power supply voltage and the second color high power supply voltage have the low level, the third color high power supply voltage has the low level in the first to third periods, and the high level in the fourth period.

In one or more embodiments, a pixel includes: a first color light-emitting element configured to display a first color; a second color light-emitting element configured to display a second color; a first sub-pixel circuit connected to the first color light-emitting element and the second color light-emitting element and configured to provide a driving current to the first color light-emitting element or the second color light-emitting element; a third color light-emitting element configured to display a third color; and a second sub-pixel circuit connected to the third color light-emitting element and configured to provide the driving current to the third color light-emitting element, wherein each of the first sub-pixel circuit and the second sub-pixel circuit includes: a first transistor including a gate electrode connected to a first node, a first electrode connected to a second node, and a second electrode connected to a third node; a second transistor configured to connect a data line and the first node in response to a data write gate signal; a third transistor configured to provide a compensation voltage to the second node in response to a compensation gate signal; and a fourth transistor configured to provide a low power supply voltage to the third node in response to an emission signal.

In one or more embodiments, the first to fourth transistors are N-type transistors.

In one or more embodiments, the first color light-emitting element includes an anode electrode configured to receive a first color high power supply voltage and a second electrode connected to a cathode node, wherein the second color light-emitting element includes an anode electrode configured to receive a second color high power supply voltage and a cathode electrode connected to the second node, and wherein the third color light-emitting element includes an anode electrode configured to receive a third color high power supply voltage and a cathode electrode connected to the second node.

In one or more embodiments, the second transistor includes a gate electrode configured to receive the data write gate signal, a first electrode connected to the data line, and a second electrode connected to the first node.

In one or more embodiments, the third transistor includes a gate electrode configured to receive the compensation gate signal, a first electrode configured to receive the compensation voltage, and a second electrode connected to the second node.

In one or more embodiments, the fourth transistor includes a gate electrode configured to receive the emission signal, a first electrode configured to receive the low power supply voltage, and a second electrode connected to the third node.

In one or more embodiments, each of the first sub-pixel circuit and the second sub-pixel circuit further includes a first capacitor including a first electrode connected to the first node and a second electrode connected to the third node.

In one or more embodiments, each of the first sub-pixel circuit and the second sub-pixel circuit further includes a second capacitor including a first electrode connected to the third node and a second electrode configured to receive the low power supply voltage.

In one or more embodiments, an electronic device includes: a display panel including a pixel; a gate driver configured to provide a gate signal to the pixel; a data driver configured to provide a data voltage to the pixel; an emission driver configured to provide an emission signal to the pixel; and a driving controller configured to control the gate driver, the data driver, and the emission driver, wherein the pixel includes: a first color light-emitting element configured to display a first color; a second color light-emitting element configured to display a second color; a third color light-emitting element configured to display a third color; and a pixel circuit connected to the first color light-emitting element, the second color light-emitting element, and the third color light-emitting element and configured to provide a driving current to the first color light-emitting element, the second color light-emitting element, or the third color light-emitting element, wherein the pixel circuit includes: a first transistor including a gate electrode connected to a first node, a first electrode connected to a second node, and a second electrode connected to a third node; a second transistor configured to connect a data line and the first node in response to a data write gate signal; a third transistor configured to provide a compensation voltage to the second node in response to a compensation gate signal; and a fourth transistor configured to provide a low power supply voltage to the third node in response to the emission signal.

According to the pixel and the display device including the pixel according to embodiments of the present disclosure, the pixel may include light-emitting elements and a pixel circuit, and the light-emitting elements may share the pixel circuit. Accordingly, the pixel may have a low area and a high PPI.

### BRIEF DESCRIPTION OF THE DRAWINGS

The above and other features of embodiments of the present disclosure will become more apparent by describing in detailed embodiments thereof with reference to the accompanying drawings, in which:

FIG. 1 is a block diagram showing a display device according to one or more embodiments of the present disclosure;

FIG. 2 is a circuit diagram showing an example of a pixel of FIG. 1;

FIGS. 3 and 4 are timing diagrams showing an example of operating the pixel of FIG. 2;

FIG. 5 is a circuit diagram showing an example of an operation of the pixel of FIG. 2 in the first period of FIG. 4;

FIG. 6 is a circuit diagram showing an example of an operation of the pixel of FIG. 2 in a second period of FIG. 4;

FIG. 7 is a circuit diagram showing an example of an operation of the pixel of FIG. 2 in a third period of FIG. 4;

FIG. 8 is a circuit diagram showing an example of an operation of the pixel of FIG. 2 in a fourth period of FIG. 4;

FIG. 9 is a circuit diagram showing an example of a pixel of FIG. 1;

FIG. 10 is a timing diagram showing an example of operating the pixel of FIG. 9;

FIG. 11 is a timing diagram showing an example of operating a pixel of FIG. 9;

FIG. 12 is a block diagram showing an electronic device; and

FIG. 13 is a diagram showing an embodiment in which an electronic device of FIG. 12 is implemented as a VR device.

### DETAILED DESCRIPTION

The embodiments will now be described more fully hereinafter with reference to the accompanying drawings. The embodiments may, however, be provided in different forms and should not be construed as limiting. The same reference numbers indicate the same components throughout the present disclosure. In the accompanying figures, the thickness of layers and regions may be exaggerated for clarity.

Some of the parts which are not associated with the description may not be provided in order to describe embodiments of the present disclosure.

It will also be understood that when a layer is referred to as being “on” another layer or substrate, it can be directly on the other layer or substrate, or intervening layers may also be present. In contrast, when an element is referred to as being “directly on” another element, there may be no intervening elements present.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

The spatially relative terms “below,” “beneath,” “lower,” “above,” “upper,” and/or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in other directions and thus the spatially relative terms may be interpreted differently depending on the orientations.

When an element is referred to as being “connected” or “coupled” to another element, the element may be “directly connected” or “directly coupled” to another element, or “electrically connected” or “electrically coupled” to another element with one or more intervening elements interposed therebetween. It will be further understood that when the terms “comprises,” “comprising,” “has,” “have,” “having,” “includes” and/or “including” are used, they may specify the presence of stated features, integers, steps, operations, elements and/or components, but do not preclude the presence or addition of other features, integers, steps, operations, elements, components, and/or any combination thereof.

It will be understood that, although the terms “first,” “second,” “third,” and/or the like may be used herein to describe various elements, these elements should not be limited by these terms. These terms are used to distinguish one element from another element or for the convenience of description and explanation thereof. For example, when “a first element” is discussed in the description, it may be termed “a second element” or “a third element,” and “a second element” and “a third element” may be termed in a similar manner without departing from the teachings herein.

The terms “about” or “approximately” as used herein is inclusive of the stated value and means within an acceptable range of deviation for the particular value as determined by one of ordinary skill in the art, considering the measurement in question and the error associated with measurement of the particular quantity (for example, the limitations of the measurement system). For example, “about” may mean within one or more standard deviations, or within ±30%, 20%, 10%, 5% of the stated value.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.” In the specification and the claims, the phrase “at least one of” is intended to include the meaning of “at least one selected from the group of” for the purpose of its meaning and interpretation. For example, “at least one of A and B” may be understood to mean “A, B, or A and B.”

Unless otherwise defined or implied, all terms used herein (including technical and scientific terms) have the same meaning as commonly understood by those skilled in the art to which this disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the specification.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, the present disclosure will be described in more detail with reference to the accompanying drawings.

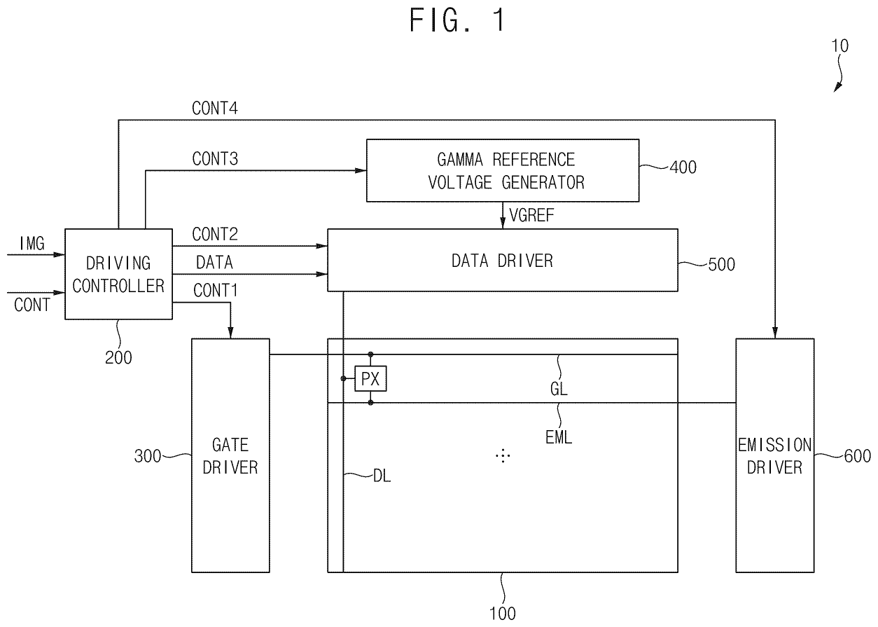

FIG. 1 is a block diagram showing a display device 10 according to embodiments of the present disclosure.

Referring to FIG. 1, a display device 10 may include a display panel 100 and a display panel driver. The display panel driver may include a driving controller 200, a gate driver 300, a gamma reference voltage generator 400, a data driver 500, and an emission driver 600.

For example, the driving controller 200 and the data driver 500 may be formed integrally. For example, the driving controller 200, the gamma reference voltage generator 400, and the data driver 500 may be formed integrally. For example, the driving controller 200, the gate driver 300, the gamma reference voltage generator 400, and the data driver 500 may be formed integrally. For example, the driving controller 200, the gate driver 300, the gamma reference voltage generator 400, the data driver 500, and the emission driver 600 may be formed integrally. In one or more embodiments, a driving module in which at least the driving controller 200 and the data driver 500 are formed integrally may be named a timing controller embedded data driver (TED).

The display panel 100 may include a display area for displaying an image and a peripheral area disposed adjacent to the display area.

For example, the display panel 100 may be an organic light-emitting diode display panel including an organic light-emitting diode (OLED). For another example, the display panel 100 may be a quantum-dot organic light-emitting diode display panel including an organic light-emitting diode and a quantum-dot color filter. For another example, the display panel 100 may be a quantum-dot nano light-emitting diode display panel including a nano light-emitting diode and a quantum-dot color filter. For another example, the display panel 100 may be a liquid crystal display panel including a liquid crystal layer.

The display panel 100 may include gate lines GL, data lines DL, emission lines EML, and pixels PX electrically connected to the gate lines GL, the data lines DL, and the emission lines EML, respectively. The gate lines GL may extend in a first direction, the data lines DL may extend in a second direction crossing the first direction, and the emission lines EML may extend in the first direction.

The driving controller 200 may receive input image data IMG and an input control signal CONT from an external device. For example, the input image data IMG may include red image data, green image data, and blue image data. The input image data IMG may include white image data. The input image data IMG may include magenta image data, yellow image data, and/or cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The gate driver 300 may generate gate signals for driving the gate lines GL in response to the first control signal CONT1 received from the driving controller 200. The gate driver 300 may output the gate signals to the gate lines GL.

In one or more embodiments, the gate driver 300 may be integrated on the peripheral area of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

For example, the gamma reference voltage generator 400 may be disposed within the driving controller 200 or may be disposed within the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

The emission driver 600 may generate emission signals for driving the emission lines EML in response to the fourth control signal CONT4 received from the driving controller 200. The emission driver 600 may output the emission signals to the emission lines EML.

In one or more embodiments, the emission driver 600 may be integrated in the peripheral area of the display panel 100. In one or more embodiments, the emission driver 600 may be mounted in the peripheral area of the display panel 100.

In FIG. 1, for a convenience of an explanation, the gate driver 300 may be disposed on a first side of the display panel 100 and the emission driver 600 may be disposed on a second side of the display panel 100. Although shown, the present disclosure is not limited thereto. For example, both the gate driver 300 and the emission driver 600 may be disposed on the first side of the display panel 100. For example, both the gate driver 300 and the emission driver 600 may be disposed on both sides of the display panel 100. For example, the gate driver 300 and the emission driver 600 may be formed integrally.

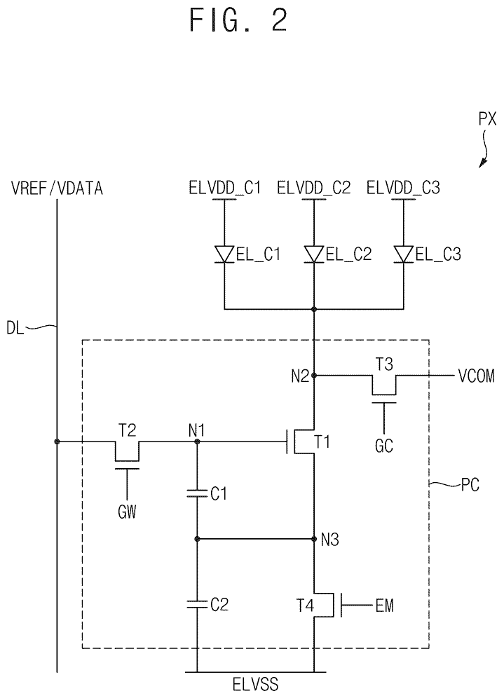

FIG. 2 is a circuit diagram showing an example of a pixel PX of FIG. 1.

Referring to FIG. 2, a pixel PX may include a first color light-emitting element EL_C1 configured to display a first color, a second color light-emitting element EL_C2 configured to display a second color, a third color light-emitting element EL_C3 configured to display a third color, and a pixel circuit PC which is connected to the first color light-emitting element EL_C1, the second color light-emitting element EL_C2, and the third color light-emitting element EL_C3 to provide a driving current to the first color light-emitting element EL_C1, the second color light-emitting element EL_C2, or the third color light-emitting element EL_C3. In one or more embodiments, the first color may be red, the second color may be green, and the third color may be blue. The pixel circuit PC may include first to fourth transistors T1 to T4. In one or more embodiments, the first to fourth transistors T1 to T4 may be N-type transistors. However, the present disclosure is not limited thereto. The first to fourth transistors T1 to T4 may be P-type transistors.

The first transistor T1 may include a gate electrode connected to a first node N1, a first electrode connected to a second node N2, and a second electrode connected to a third node N3.

The second transistor T2 may include a gate electrode configured to receive a data write gate signal GW, a first electrode connected to a data line DL configured to transmit a reference voltage VREF or a data voltage VDATA, and a second electrode connected to the first node N1.

The third transistor T3 may include a gate electrode configured to receive a compensation gate signal GC, a first electrode configured to receive a compensation voltage VCOM, and a second electrode connected to the second node N2.

The fourth transistor T4 may include a gate electrode configured to receive an emission signal EM, a first electrode configured to receive a low power supply voltage ELVSS, and a second electrode connected to the third node N3.

The first color light-emitting element EL_C1 may include an anode electrode configured to receive a first color high power supply voltage ELVDD_C1 and a cathode electrode connected to the second node N2.

The second color light-emitting element EL_C2 may include an anode electrode configured to receive a second color high power supply voltage ELVDD_C2 and a cathode electrode connected to the second node N2.

The third color light-emitting element EL_C3 may include an anode electrode configured to receive a third color high power supply voltage ELVDD_C3 and a cathode electrode connected to the second node N2.

The pixel circuit PC may further include a first capacitor C1 and a second capacitor C2.

The first capacitor C1 may include a first electrode connected to the first node N1 and a second electrode connected to the third node N3.

The second capacitor C2 may include a first electrode connected to the third node N3 and a second electrode receiving the low power supply voltage ELVSS.

As such, the first color light-emitting element EL_C1, the second color light-emitting element EL_C2, and the third color light-emitting element EL_C3 may share the pixel circuit PC. Accordingly, the pixel PX may have a low area and a high PPI (Pixels Per Inch).

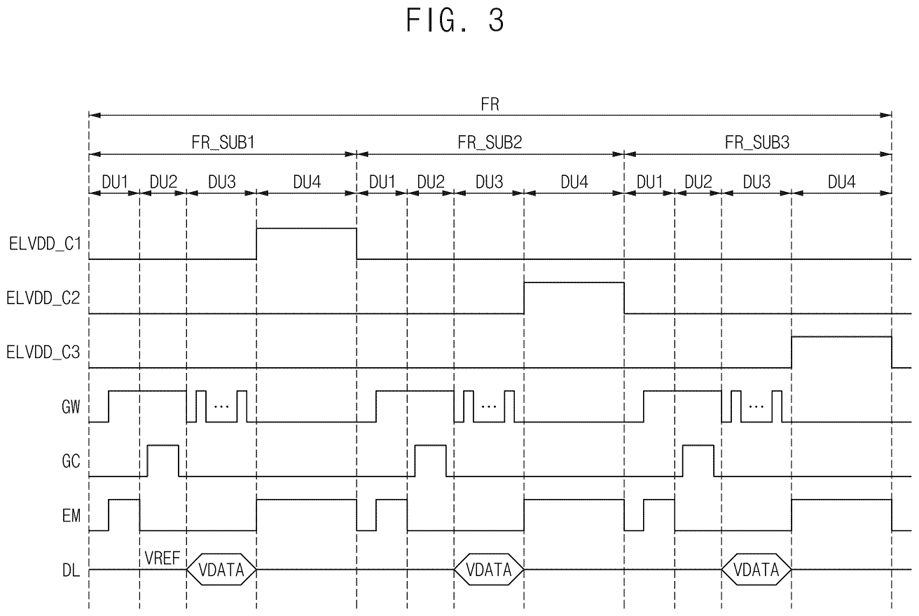

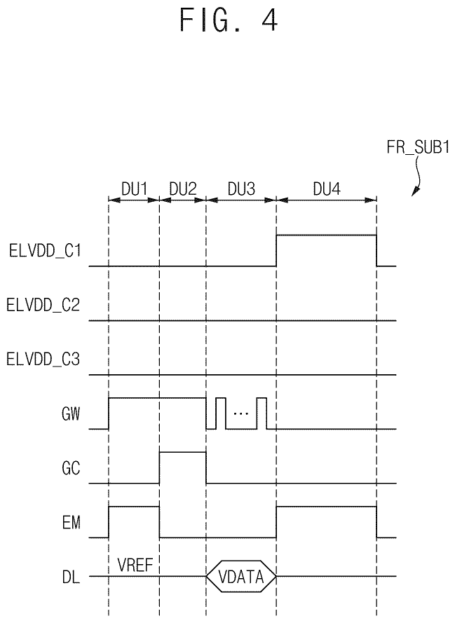

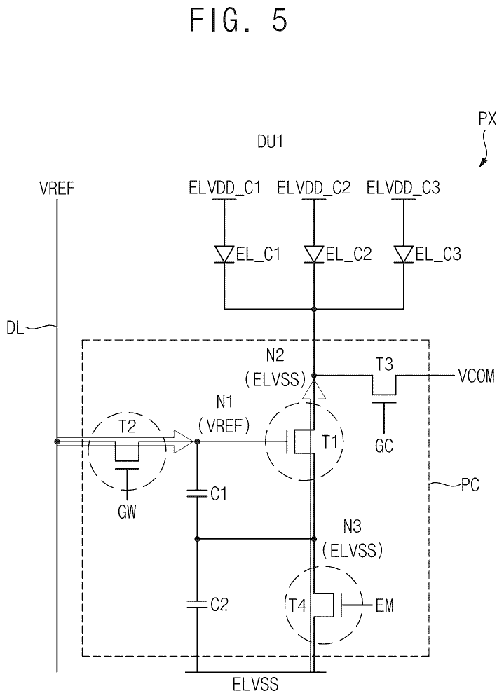

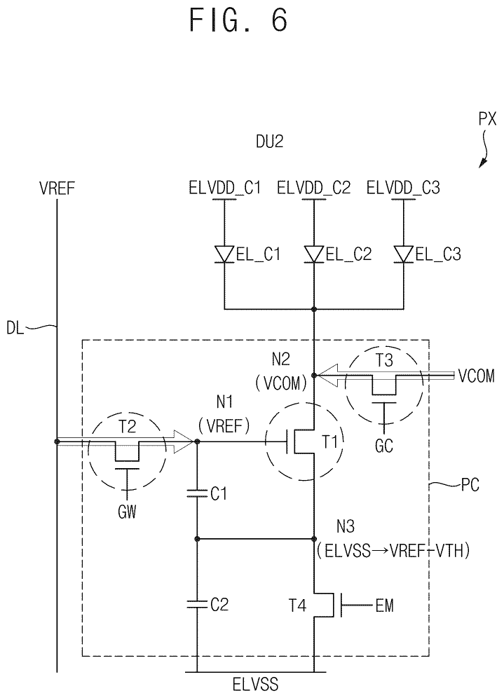

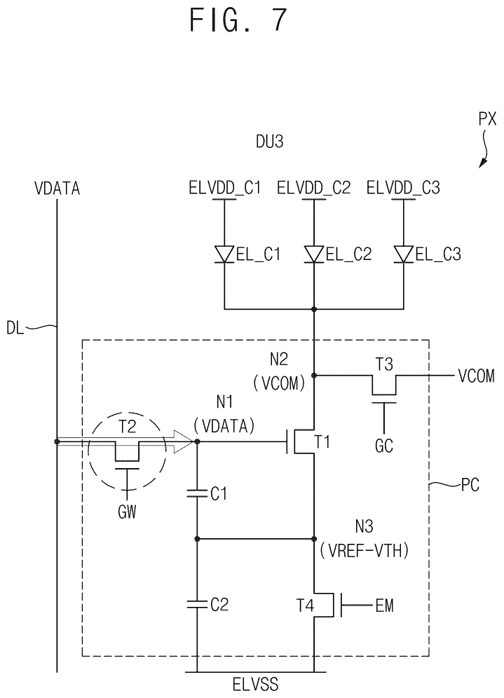

FIGS. 3 and 4 are timing diagrams showing an example of operating the pixel PX of FIG. 2. FIG. 5 is a circuit diagram showing an example of an operation of the pixel PX of FIG. 2 in the first period DU1 of FIG. 4. FIG. 6 is a circuit diagram showing an example of an operation of the pixel PX of FIG. 2 in a second period DU2 of FIG. 4. FIG. 7 is a circuit diagram showing an example of an operation of the pixel PX of FIG. 2 in a third period DU3 of FIG. 4. FIG. 8 is a circuit diagram showing an example of an operation of the pixel PX of FIG. 2 in a fourth period DU4 of FIG. 4.

Referring to FIG. 3, a frame period FR for the pixel PX may include first to third sub-frame periods FR_SUB1 to FR_SUB3. The first sub-frame period FR_SUB1 may drive the first color light-emitting element EL_C1. The second sub-frame period FR_SUB2 may be continuous with the first sub-frame period FR_SUB1 and may drive the second color light-emitting element EL_C2. The third sub-frame period FR_SUB3 may be continuous with the second sub-frame period FR_SUB2 and may drive the third color light-emitting element EL_C3.

Each of the first to third sub-frame periods FR_SUB1 to FR_SUB3 may include first to fourth periods DU1 to DU4. In the first sub-frame period FR_SUB1, the second color high power supply voltage ELVDD_C2 and the third color high power supply voltage ELVDD_C3 may have the low level, the first color high power supply voltage ELVDD_C1 may have the low level in the first to third periods DU1 to DU3, and may have the high level in the fourth period DU4. In the second sub-frame period FR_SUB2, the third color high power supply voltage ELVDD_C3 and the first color high power supply voltage ELVDD_C1 may have the low level, and the second color high power supply voltage ELVDD_C2 may have the low level in the first to third periods DU1 to DU3, and may have the high level in the fourth period DU4. In the third sub-frame period FR_SUB3, the first color high power supply voltage ELVDD_C1 and the second color high power supply voltage ELVDD_C2 may have the low level, the third color high power supply voltage ELVDD_C3 may have the low level in the first to third periods DU1 to DU3, and may have the high level in the fourth period DU4. In the first to third sub-frame periods FR_SUB1 to FR_SUB3, the low power supply voltage ELVSS may be constant, and the low power supply voltage ELVSS may be equal to the low level of each of the first to third color high power supply voltages ELVDD_C1 to ELVDD_C3.

Referring to FIGS. 4-8 , the first sub-frame period FR_SUB1 may drive the first color light-emitting element EL_C1.

Referring to FIG. 4 and FIG. 5, in the first period DU1, the first to third color high power supply voltages ELVDD_C1 to ELVDD_C3 may have the low level, the data write gate signal GW may have the high level, the compensation gate signal GC may have the low level, the emission signal EM may have the high level, and the data line DL may transmit the reference voltage VREF.

The second transistor T2 may be turned on in response to the data write gate signal GW having the high level to provide the reference voltage VREF transmitted from the data line DL to the first node N1. Therefore, a voltage of the first node N1 may be the reference voltage VREF.

The third transistor T3 may be turned off in response to the compensation gate signal GC having the low level.

The fourth transistor T4 may be turned on in response to the emission signal EM having the high level to provide the low power supply voltage ELVSS to the third node N3. Therefore, a voltage of the third node N3 may be the low power supply voltage ELVSS.

The reference voltage VREF may be at least as large as a threshold voltage of the first transistor T1 and may be greater than the low power supply voltage ELVSS. Therefore, a gate-source voltage of the first transistor T1 may be equal to or greater than the threshold voltage of the first transistor T1, and the first transistor T1 may be turned on to provide the voltage of the third node N3 to the second node N2. Therefore, a voltage of the second node N2 may be the low power supply voltage ELVSS.

Because the voltage of the first node N1 is initialized to the reference voltage VREF and the voltage of the third node N3 is initialized to the low power supply voltage ELVSS, the first period DU1 may be an initialization period.

Referring to FIG. 4 and FIG. 6, in the second period DU2, the first to third color high power supply voltages ELVDD_C1 to ELVDD_C3 may have the low level, the data write gate signal GW may have the high level, the compensation gate signal GC may have the high level, the emission signal EM may have the low level, and the data line DL may transmit the reference voltage VREF.

The second transistor T2 may be turned on in response to the data write gate signal GW having the high level to provide the reference voltage VREF transmitted from the data line DL to the first node N1. Therefore, the voltage of the first node N1 may be the reference voltage VREF.

The third transistor T3 may be turned on in response to the compensation gate signal GC having the high level to provide the compensation voltage VCOM to the second node N2. Therefore, the voltage of the second node N2 may be the compensation voltage VCOM. The compensation voltage VCOM may be equal to the high level of each of the first to third color high power supply voltages ELVDD_C1 to ELVDD_C3.

The fourth transistor T4 may be turned off in response to the emission signal EM having the low level.

The voltage of the second node N2 is fixed to the compensation voltage VCOM by the third transistor T3, while the voltage of the third node N3 is not fixed to the low power supply voltage ELVSS by the fourth transistor T4. Therefore, the first transistor T1 may provide the voltage of the second node N2 to the third node N3. The voltage of the third node N3 may be changed from the low power supply voltage ELVSS to a voltage obtained by subtracting the threshold voltage VTH of the first transistor T1 from the reference voltage VREF. After the voltage of the third node N3 is changed to the voltage obtained by subtracting the threshold voltage VTH of the first transistor T1 from the reference voltage VREF, the first transistor T1 may be turned off.

Because the voltage of the first node N1 is the reference voltage VREF and the voltage of the third node N3 is the voltage obtained by subtracting the threshold voltage VTH of the first transistor T1 from the reference voltage VREF, the first capacitor C1 may store the threshold voltage VTH of the first transistor T1, and the threshold voltage VTH of the first transistor T1 may be compensated. Therefore, the second period DU2 may be a compensation period.

Referring to FIG. 4 and FIG. 7, in the third period DU3, the first to third color high power supply voltages ELVDD_C1 to ELVDD_C3 may have the low level, the data write gate signal GW may have the high level, the compensation gate signal GC may have the low level, the emission signal EM may have the low level, and the data line DL may transmit the data voltage VDATA.

The second transistor T2 may be turned on in response to the data write gate signal GW having the high level to provide the data voltage VDATA transmitted from the data line DL to the first node N1. Therefore, the voltage of the first node N1 may be the data voltage VDATA.

The third transistor T3 may be turned off in response to the compensation gate signal GC having the low level. Therefore, the voltage of the second node N2 may maintain the compensation voltage VCOM.

The fourth transistor T4 may be turned off in response to the emission signal EM having the low level. Therefore, the voltage of the third node N3 may maintain the voltage obtained by subtracting the threshold voltage VTH of the first transistor T1 from the reference voltage VREF.

Referring to FIG. 4 and FIG. 8, in the fourth period DU4, the first color high power supply voltage ELVDD_C1 may have the high level, the second color high power supply voltage ELVDD_C2 and the third color high power supply voltage ELVDD_C3 may have the low level, the data write gate signal GW may have the low level, the compensation gate signal GC may have the low level, the emission signal EM may have the high level, and the data line DL may transmit the reference voltage VREF.

The second transistor T2 may be turned off in response to the data write gate signal GW having the low level. The third transistor T3 may be turned off in response to the compensation gate signal GC having the low level.

The fourth transistor T4 may be turned on in response to the emission signal EM having the high level. The first transistor T1 may be turned on based on the voltage of the first node N1 and the voltage of the third node N3 to generate the driving current. An intensity of the driving current may be determined based on the voltage of the first node N1 and the voltage of the third node N3. The first color high power supply voltage ELVDD_C1 may have the high level. Therefore, a driving current path connecting the first color high power supply voltage ELVDD_C1, the first color light-emitting element EL_C1, the first transistor T1, the fourth transistor T4, and the low power supply voltage ELVSS may be formed. The first color light-emitting element EL_C1 may emit a light indicating the first color based on the driving current flowing along the driving current path.

As such, the first color light-emitting element EL_C1 may be driven in the first sub-frame period FR_SUB1 to display the first color. The second color light-emitting element EL_C2 and the third color light-emitting element EL_C3 may display the second color and the third color in the second sub-frame period FR_SUB2 and the third sub-frame period FR_SUB3, respectively, similar to the first color light-emitting element EL_C1. Duplicate descriptions are omitted.

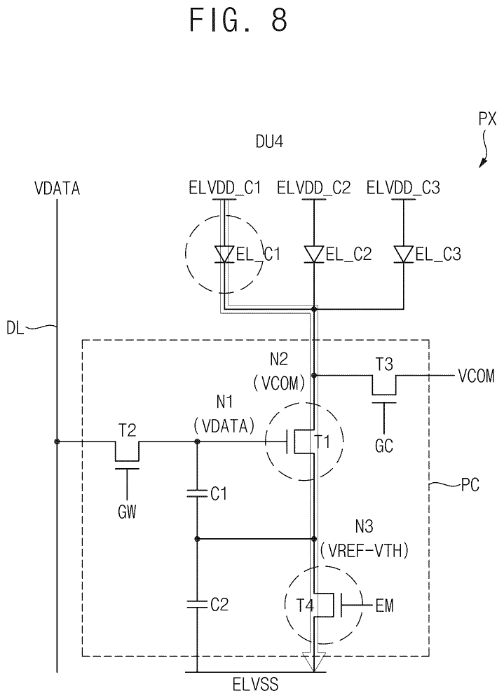

FIG. 9 is a circuit diagram showing an example of a pixel PX of FIG. 1.

Referring to FIGS. 1 and 9, a pixel PX may include a first color light-emitting element EL_C1 configured to display a first color, a second color light-emitting element EL_C2 configured to display a second color, and a first sub-pixel circuit PC_SUB1 connected to the first color light-emitting element EL_C1 and the second color light-emitting element EL_C2 to provide a driving current to the first color light-emitting element EL_C1 or the second color light-emitting element EL_C2. The pixel PX may further include a third color light-emitting element EL_C3 configured to display a third color, and a second sub-pixel circuit PC_SUB2 connected to the third color light-emitting element EL_C3 to provide the driving current to the third color light-emitting element EL_C3. In one or more embodiments, the first color may be red, the second color may be green, and the third color may be blue. In one or more embodiments, the first color may be the green, the second color may be the blue, and the third color may be the red. In one or more embodiments, the first color may be the blue, the second color may be the red, and the third color may be the green. Each of the first sub-pixel circuit PC_SUB1 and the second sub-pixel circuit PC_SUB2 may include first to fourth transistors T1 to T4. In one or more embodiments, the first to fourth transistors T1 to T4 may be N-type transistors. However, the present disclosure is not limited thereto. The first to fourth transistors T1 to T4 may be P-type transistors.

The first transistor T1 may include a gate electrode connected to a first node N1, a first electrode connected to a second node N2, and a second electrode connected to a third node N3.

The second transistor T2 may include a gate electrode receiving a data write gate signal GW, a first electrode connected to a data line DL (E.G., DL1OR DL2) configured to transmit a reference voltage VREF or a data voltage VDATA, and a second electrode connected to the first node N1. For example, as shown in FIG. 9, the second transistor T2 of the first sub-pixel circuit PC_SUB1 may be connected to the first data line DL1 and the second transistor T2 of the second sub-pixel circuit PC_SUB2 may be connected to the second data line DL2.

The third transistor T3 may include a gate electrode configured to receive a compensation gate signal GC, a first electrode configured to receive a compensation voltage VCOM, and a second electrode connected to the second node N2.

The fourth transistor T4 may include a gate electrode configured to receive an emission signal EM, a first electrode configured to receive a low power supply voltage ELVSS, and a second electrode connected to the third node N3.

The first color light-emitting element EL_C1 may include an anode electrode configured to receive a first color high power supply voltage ELVDD_C1 and a cathode electrode connected to the second node N2.

The second color light-emitting element EL_C2 may include an anode electrode configured to receive a second color high power supply voltage ELVDD_C2 and a cathode electrode connected to the second node N2.

The third color light-emitting element EL_C3 may include an anode electrode configured to receive a third color high power supply voltage ELVDD_C3 and a cathode electrode connected to the second node N2.

The first sub-pixel circuit PC_SUB1 and the second sub-pixel circuit PC_SUB2 may further include a first capacitor C1 and a second capacitor C2.

The first capacitor C1 may include a first electrode connected to the first node N1 and a second electrode connected to the third node N3.

The second capacitor C2 may include a first electrode connected to the third node N3 and a second electrode configured to receive the low power supply voltage ELVSS.

As such, the first color light-emitting element EL_C1 and the second color light-emitting element EL_C2 may share the first sub-pixel circuit PC_SUB1. Accordingly, the pixel PX may have a low area and a high PPI.

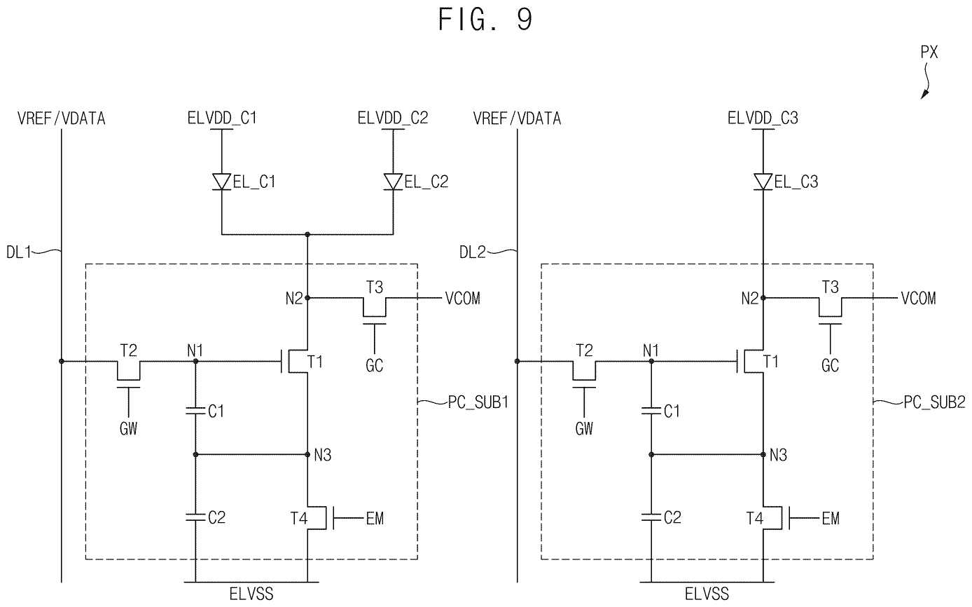

FIG. 10 is a timing diagram showing an example of operating a pixel PX of FIG. 9.

Referring to FIGS. 9 and 10, a frame period FR for the pixel PX may include first to third sub-frame periods FR_SUB1 to FR_SUB3. The first sub-frame period FR_SUB1 may drive the first color light-emitting element EL_C1. The second sub-frame period FR_SUB2 may be continuous with the first sub-frame period FR_SUB1 and may drive the second color light-emitting element EL_C2. The third sub-frame period FR_SUB3 includes the first sub-frame period FR_SUB1 and the second sub-frame period FR_SUB2 and may drive the third color light-emitting element EL_C3.

A length of each of pulses included in the third sub-frame period FR_SUB3 may be twice the length of each of pulses included in the first sub-frame period FR_SUB1 and the second sub-frame period FR_SUB2.

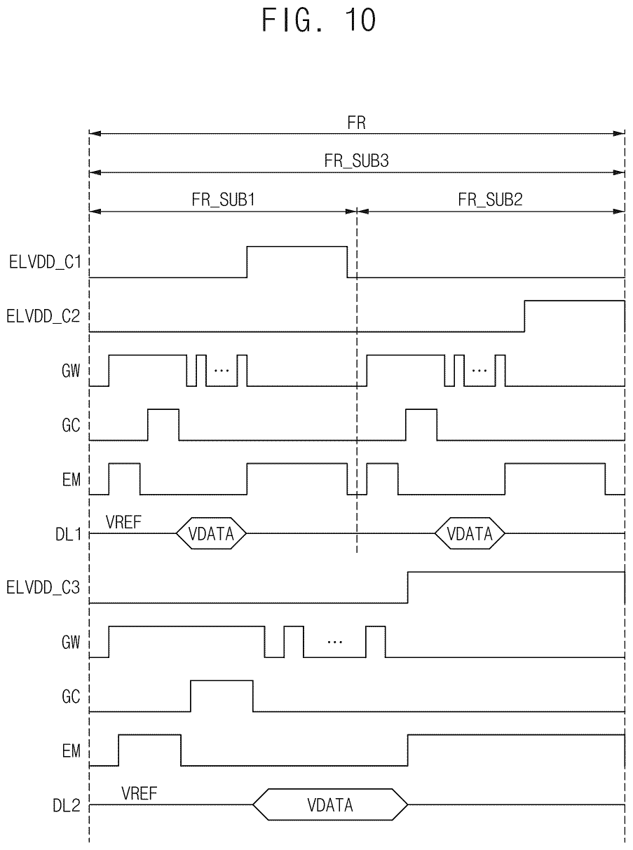

FIG. 11 is a timing diagram showing an example of operating a pixel PX of FIG. 9.

Referring to FIGS. 9 and 11, a frame period FR for the pixel PX may include first to third sub-frame periods FR_SUB1 to FR_SUB3. The first sub-frame period FR_SUB1 may drive the first color light-emitting element EL_C1. The second sub-frame period FR_SUB2 may be continuous to the first sub-frame period FR_SUB1 and may drive the second color light-emitting element EL_C2. The third sub-frame period FR_SUB3 includes the first sub-frame period FR_SUB1 and the second sub-frame period FR_SUB2 and may drive the third color light-emitting element EL_C3.

A length of each of pulses included in the third sub-frame period FR_SUB3 may be equal to a length of each of pulses included in the first sub-frame period FR_SUB1 and the second sub-frame period FR_SUB2.

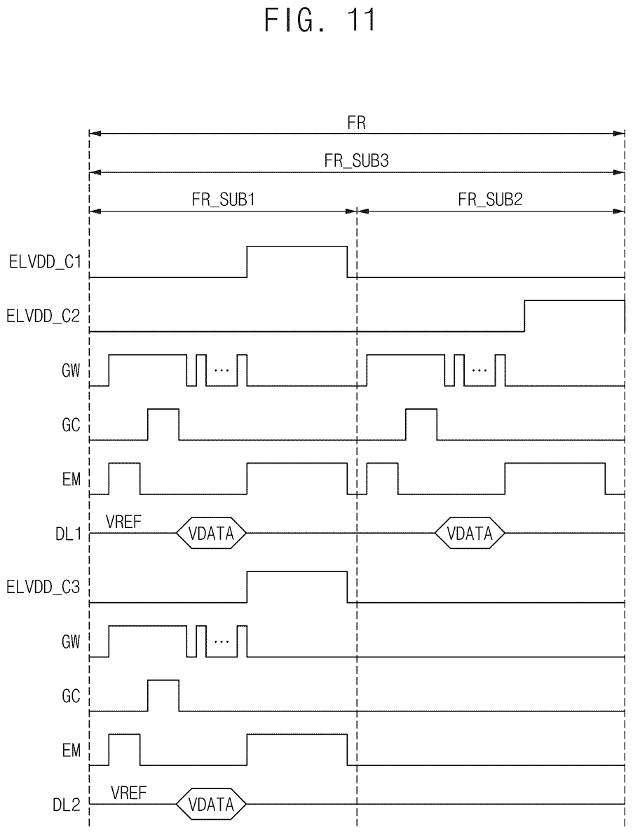

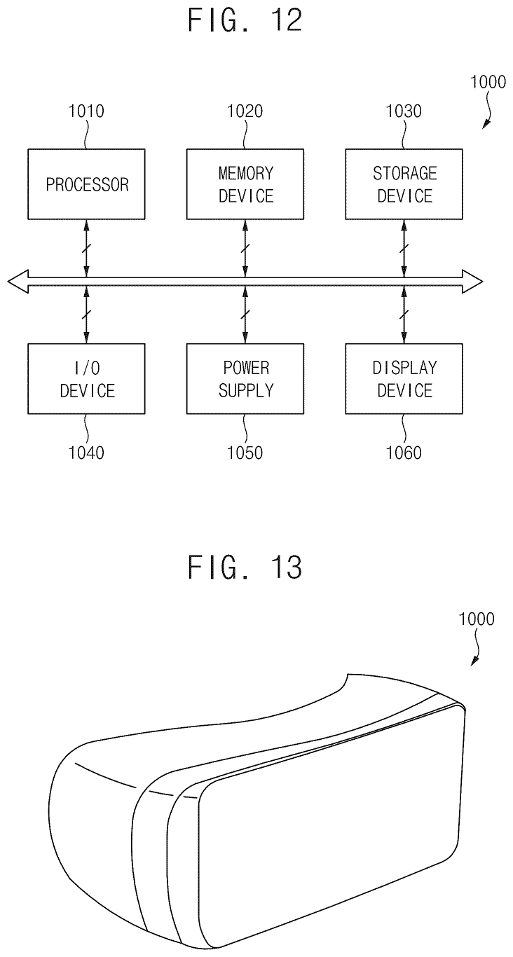

FIG. 12 is a block diagram showing an electronic device 1000. FIG. 13 is a diagram showing an embodiment in which an electronic device 1000 of FIG. 12 is implemented as a virtual reality (VR) device.

Referring to FIGS. 12 and 13, an electronic device 1000 may include a processor 1010, a memory device 1020, a storage device 1030, an input/output I/O device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, other electronic device, and/or the like.

In one or more embodiments, as shown in FIG. 13, the electronic device 1000 may be implemented as the VR device. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display HMD device, and/or the like.

The processor 1010 may perform various computing functions. The processor 1010 may be a micro-processor, a central processing unit CPU, an application processor AP, and/or the like. The processor 1010 may be coupled to other components via an address bus, a control bus, a data bus, and/or the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and/or the like and/or at least one volatile memory device such as a dynamic random access memory DRAM device, a static random access memory SRAM device, a mobile DRAM device, and/or the like.

The storage device 1030 may include a solid state drive SSD device, a hard disk drive HDD device, a CD-ROM device, and/or the like.

The I/O device 1040 may include an input device such as a keyboard, a keypad, a mouse device, a touch-pad, a touch-screen, and/or the like, and an output device such as a printer, a speaker, and/or the like. In one or more embodiments, the I/O device 1040 may include the display device 1060.

The power supply 1050 may provide power for operations of the electronic device 1000.

The display device 1060 may be connected to other components through buses or other communication links.

The present disclosure may be applied to any display device and any electronic device including the touch panel. For example, the present disclosure may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and scope of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the embodiments, as well as other embodiments, are intended to be included within the scope of the appended claims and their equivalents. The present disclosure is defined by the following claims, with equivalents of the claims to be included therein.

What is claimed is:

1. A pixel, comprising:
a first color light-emitting element configured to display a first color;
a second color light-emitting element configured to display a second color;
a third color light-emitting element configured to display a third color; and
a pixel circuit connected to the first color light-emitting element, the second color light-emitting element, and the third color light-emitting element and configured to provide a driving current to the first color light-emitting element, the second color light-emitting element, or the third color light-emitting element,
wherein the pixel circuit comprises:
a first transistor comprising a gate electrode connected to a first node, a first electrode connected to a second node, and a second electrode connected to a third node;
a second transistor configured to connect a data line and the first node in response to a data write gate signal;
a third transistor configured to provide a compensation voltage to the second node in response to a compensation gate signal; and
a fourth transistor configured to provide a low power supply voltage to the third node in response to an emission signal.

2. The pixel of claim 1, wherein the first to fourth transistors are N-type transistors.

3. The pixel of claim 1, wherein the first color light-emitting element comprises an anode electrode configured to receive a first color high power supply voltage and a cathode electrode connected to the second node,
wherein the second color light-emitting element comprises an anode electrode configured to receive a second color high power supply voltage and a cathode electrode connected to the second node, and
wherein the third color light-emitting element comprises an anode electrode configured to receive a third color high power supply voltage and a cathode electrode connected to the second node.

4. The pixel of claim 1, wherein the second transistor comprises a gate electrode configured to receive the data write gate signal, a first electrode connected to the data line, and a second electrode connected to the first node.

5. The pixel of claim 1, wherein the third transistor comprises a gate electrode configured to receive the compensation gate signal, a first electrode configured to receive the compensation voltage, and a second electrode connected to the second node.

6. The pixel of claim 1, wherein the fourth transistor comprises a gate electrode configured to receive the emission signal, a first electrode configured to receive the low power supply voltage, and a second electrode connected to the third node.

7. The pixel of claim 1, wherein the pixel circuit further comprises a first capacitor comprising a first electrode connected to the first node and a second electrode connected to the third node.

8. The pixel of claim 1, wherein the pixel circuit further comprises a second capacitor comprising a first electrode connected to the third node and a second electrode configured to receive the low power supply voltage.

9. The pixel of claim 1, wherein a frame period for the pixel comprises a first sub-frame period for driving the first color light-emitting element, a second sub-frame period continuous to the first sub-frame period for driving the second color light-emitting element, and a third sub-frame period continuous to the second sub-frame period for driving the third color light-emitting element.

10. The pixel of claim 9, wherein each of the first to third sub-frame periods comprises a first period, a second period, a third period, and a fourth period,
wherein in the first period, the data write gate signal has a high level, the compensation gate signal has a low level, the emission signal has the high level, and the data line is configured to transmit a reference voltage,
wherein in the second period, the data write gate signal has the high level, the compensation gate signal has the high level, the emission signal has the low level, and the data line is configured to transmit the reference voltage,
wherein in the third period, the data write gate signal has the high level, the compensation gate signal has the low level, the emission signal has the low level, and the data line is configured to transmit a data voltage, and
wherein in the fourth period, the data write gate signal has the low level, the compensation gate signal has the low level, the emission signal has the high level, and the data line is configured to transmit the reference voltage.

11. The pixel of claim 10, wherein in the first sub-frame period, a second color high power supply voltage and a third color high power supply voltage have the low level, a first color high power supply voltage has the low level in the first to third periods, and the high level in the fourth period,
wherein in the second sub-frame period, the third color high power supply voltage and the first color high power supply voltage have the low level, the second color high power supply voltage has the low level in the first to third periods, and the high level in the fourth period, and
wherein in the third sub-frame period, the first color high power supply voltage and the second color high power supply voltage have the low level, the third color high power supply voltage has the low level in the first to third periods, and the high level in the fourth period.

12. A pixel, comprising:
a first color light-emitting element configured to display a first color;
a second color light-emitting element configured to display a second color;
a first sub-pixel circuit connected to the first color light-emitting element and the second color light-emitting element and configured to provide a driving current to the first color light-emitting element or the second color light-emitting element;
a third color light-emitting element configured to display a third color; and
a second sub-pixel circuit connected to the third color light-emitting element and configured to provide the driving current to the third color light-emitting element,
wherein each of the first sub-pixel circuit and the second sub-pixel circuit comprises:
a first transistor comprising a gate electrode connected to a first node, a first electrode connected to a second node, and a second electrode connected to a third node;
a second transistor configured to connect a data line and the first node in response to a data write gate signal;
a third transistor configured to provide a compensation voltage to the second node in response to a compensation gate signal; and
a fourth transistor configured to provide a low power supply voltage to the third node in response to an emission signal.

13. The pixel of claim 12, wherein the first to fourth transistors are N-type transistors.

14. The pixel of claim 12, wherein the first color light-emitting element comprises an anode electrode configured to receive a first color high power supply voltage and a second electrode connected to a cathode node,
wherein the second color light-emitting element comprises an anode electrode configured to receive a second color high power supply voltage and a cathode electrode connected to the second node, and
wherein the third color light-emitting element comprises an anode electrode configured to receive a third color high power supply voltage and a cathode electrode connected to the second node.

15. The pixel of claim 12, wherein the second transistor comprises a gate electrode configured to receive the data write gate signal, a first electrode connected to the data line, and a second electrode connected to the first node.

16. The pixel of claim 12, wherein the third transistor comprises a gate electrode configured to receive the compensation gate signal, a first electrode configured to receive the compensation voltage, and a second electrode connected to the second node.

17. The pixel of claim 12, wherein the fourth transistor comprises a gate electrode configured to receive the emission signal, a first electrode configured to receive the low power supply voltage, and a second electrode connected to the third node.

18. The pixel of claim 12, wherein each of the first sub-pixel circuit and the second sub-pixel circuit further comprises a first capacitor comprising a first electrode connected to the first node and a second electrode connected to the third node.

19. The pixel of claim 12, wherein each of the first sub-pixel circuit and the second sub-pixel circuit further comprises a second capacitor comprising a first electrode connected to the third node and a second electrode configured to receive the low power supply voltage.

20. An electronic device, comprising:
a display panel comprising a pixel;
a gate driver configured to provide a gate signal to the pixel;
a data driver configured to provide a data voltage to the pixel;
an emission driver configured to provide an emission signal to the pixel; and
a driving controller configured to control the gate driver, the data driver, and the emission driver,
wherein the pixel comprises:
a first color light-emitting element configured to display a first color;
a second color light-emitting element configured to display a second color;
a third color light-emitting element configured to display a third color; and
a pixel circuit connected to the first color light-emitting element, the second color light-emitting element, and the third color light-emitting element and configured to provide a driving current to the first color light-emitting element, the second color light-emitting element, or the third color light-emitting element,
wherein the pixel circuit comprises:
a first transistor comprising a gate electrode connected to a first node, a first electrode connected to a second node, and a second electrode connected to a third node;
a second transistor configured to connect a data line and the first node in response to a data write gate signal;
a third transistor configured to provide a compensation voltage to the second node in response to a compensation gate signal; and
a fourth transistor configured to provide a low power supply voltage to the third node in response to the emission signal.
